(19) United States
(12) Patent Application Publication
(10) Pub. No.: US 2009/0224546 A1
(43) Pub. Date: Sep. 10, 2009

(54) Power generator utilizing a heat exchanger and circulated medium from a pulsed electrolysis system and method of using same

(76) Inventor: Nehemia Davidson, Rosh-Haayin (IL)

Correspondence Address: PATENT LAW OFFICE OF DAVID G. BECK, P. O. BOX 1146, MILL VALLEY, CA, 94942, US

(21) Appl. No.: 12/313,464

(22) Filed: Nov. 20, 2008

(30) Foreign Application Priority Data
Dec. 7, 2007 (CA) 2,613,902

(51) Int. Cl. H02K 7/18; F01K 15/00; F01K 13/00

(52) U.S. Cl. 290/52; 60/670; 60/645

(57) ABSTRACT

A power generating system (100) and a method of operating the same is provided, the system utilizing an electrolytic heating subsystem (103). The electrolytic heating subsystem is a pulsed electrolysis system that heats a heat transfer medium contained within a first conduit (109) in thermal communication with the electrolytic heating subsystem and at least one heat exchanger (105). A second conduit (117) coupled to the at least one heat exchanger contains a working fluid. As the working fluid is circulated through the second conduit and through the heat exchanger(s), it is heated to a temperature above its boiling point, causing at least a portion of the working fluid to be converted to vapor (e.g., steam). The vapor is circulated through a steam turbine (119), causing its rotation and, in turn, an electric generator (121) coupled to the steam turbine.

### CROSS-REFERENCE TO RELATED APPLICATION

Under 35 U.S.C. 119, the present application claims the benefit of the earlier filing date and the right of priority to Canadian Patent Application Serial No. 2,613,902, filed Dec. 7, 2007, the disclosure of which is hereby incorporated by reference for any and all purposes.

### FIELD OF THE INVENTION

The present invention relates generally to electric power generating systems.

### BACKGROUND OF THE INVENTION

Power generating systems in general, and steam power plants in particular, are well known in the art. This type of power generating system uses any of a variety of heat sources to heat water in order to produce steam. The steam flows into one or more turbines which spin a generator in order to produce electricity. Common heat sources used to heat the water within the boiler are coal, lignite (brown coal), fuel oil, natural gas, oil shale and nuclear reactors. In general, these systems are scalable although the extent of scalability is driven in large part by the fuel. For example, it is easier to scale a coal-fired boiler than it is to scale a boiler utilizing nuclear energy. As the temperature, pressure and quantity of steam is varied, other aspects of the system are typically scaled as well. For example, the need for pre-heaters and super-heaters depends, in part, on the size of the system. Additionally, turbine complexity varies with power plant size, ranging from small power generation systems utilizing only a single turbine to large power generation systems utilizing a series of interconnected turbines that include high pressure, intermediate pressure and low pressure turbines.

Although steam-electric power plants are well known, the current systems exhibit one or more problems. First, as previously noted, the extent of scalability varies, thus making certain power plants unusable or overly inefficient for certain applications (e.g., using a nuclear steam-electric power plant to provide power to a small community). Second, all current steam-electric power plants generate considerable environmental waste. For example, all fossil fuel based systems generate carbon dioxide, a major contributor to global warming. Fission-based nuclear reactors, while not generating carbon dioxide, produce large quantities of radioactive waste, typically on the order of 20 to 30 tons per year, which can remain toxic for hundreds of thousands of years. In addition to the problems of radioactive waste containment, removal and storage, this form of waste also adds a high degree of risk to the operation of such a power plant, both to local residents and those living hundreds of miles away. For example, the accident that occurred at Chernobyl in the Ukraine increased the radiation levels in Scotland to over 10,000 times the norm. Additionally, some nuclear reactor waste can be used to produce nuclear weapons (i.e., bombs), thus adding the cost of security to the operating costs of the power plant.

In addition to the environmental and safety issues associated with current steam-electric power plants, these systems can also lead to increased vulnerability to potential supply disruption, whether the supply is a fossil fuel such as coal or a nuclear fuel such as uranium. Additionally, obtaining such fuels, for example by mining, can have significant adverse effects on the ecosystem in the area in which the fuel is mined and processed.

Accordingly, what is needed is a steam-electric power plant that is scalable and environmentally friendly. The present invention provides such a system.

### SUMMARY OF THE INVENTION

The present invention provides a power generating system and a method of operating the same, the system utilizing an electrolytic heating subsystem. The electrolytic heating subsystem is a pulsed electrolysis system that, during operation, heats the medium contained within the electrolysis tank. The medium is pumped out of the electrolysis tank and through a conduit that is coupled to at least one heat exchanger. A second conduit, containing a working fluid, circulates the working fluid through the heat exchanger, thereby heating the working fluid to a temperature above its boiling point, causing at least a portion of the working fluid to be converted to vapor (e.g., steam). The vapor is circulated through a steam turbine, causing its rotation and, in turn, an electric generator coupled to the steam turbine.

In one embodiment of the invention, the power generating system includes an electrolytic heating subsystem comprised of an electrolysis tank, a membrane separating the electrolysis tank into two regions, at least one pair of low voltage electrodes, at least one pair of high voltage electrodes, a low voltage source, a high voltage source, and means for simultaneously pulsing both the low voltage source and the high voltage source. The system is further comprised of a first conduit coupling the electrolysis tank to a heat exchanger and a second conduit coupling the heat exchanger to a steam turbine, the steam turbine being coupled to a generator. Circulating within the first conduit is the electrolysis medium. Circulating within the second conduit is a working fluid which, upon heating, becomes vapor (e.g., steam). The system can also include a condenser for condensing the vapor after it passes through the steam turbine. The system can also include circulation pumps. The heat exchanger can be comprised of a single heat exchanger or a multi-stage heat exchanger. The system can also include one or more of a variety of sensors (e.g., electrolysis medium temperature monitor(s), working fluid temperature monitor(s), electrolysis medium level sensors, electrolysis medium pH sensors, electrolysis medium resistivity sensors, etc.). The system can also include a system controller that can be coupled to the electrolytic heating subsystem (e.g., the low and/or high voltage sources, the pulsing means, etc.), and/or a circulation pump(s), and/or the system sensors. The system can further be comprised of at least one electromagnetic coil capable of generating a magnetic field within a portion of the electrolysis tank. The system can further be comprised of at least one permanent magnet capable of generating a magnetic field within a portion of the electrolysis tank.

In one embodiment of the invention, the power generating system includes an electrolytic heating subsystem comprised of an electrolysis tank, a membrane separating the electrolysis tank into two regions, at least one pair of high voltage electrodes, a plurality of metal members contained within the electrolysis tank and interposed between the high voltage electrodes and the membrane, a high voltage source, and means for pulsing the high voltage source. The system is further comprised of a first conduit coupling the electrolysis tank to a heat exchanger and a second conduit coupling the heat exchanger to a steam turbine, the steam turbine being coupled to a generator. Circulating within the first conduit is the electrolysis medium. Circulating within the second conduit is a working fluid which, upon heating, becomes vapor (e.g., steam). The system can also include a condenser for condensing the vapor after it passes through the steam turbine. The system can also include circulation pumps. The heat exchanger can be comprised of a single heat exchanger or a multi-stage heat exchanger. The system can also include one or more of a variety of sensors (e.g., electrolysis medium temperature monitor(s), working fluid temperature monitor(s), electrolysis medium level sensors, electrolysis medium pH sensors, electrolysis medium resistivity sensors, etc.). The system can also include a system controller that can be coupled to the electrolytic heating subsystem (e.g., the voltage source, the pulsing means, etc.), and/or a circulation pump(s), and/or the system sensors. The system can further be comprised of at least one electromagnetic coil capable of generating a magnetic field within a portion of the electrolysis tank. The system can further be comprised of at least one permanent magnet capable of generating a magnetic field within a portion of the electrolysis tank.

In another aspect of the invention, a method of generating electricity is provided, the method comprising the steps of heating a liquid contained within the electrolysis tank of an electrolytic heating subsystem by performing electrolysis within the electrolysis tank, circulating the heated liquid from the electrolysis tank through a heat exchanger via a first conduit, circulating a working fluid through a second conduit coupled to the heat exchanger, wherein the working fluid is heated to a temperature above its boiling point as it passes through the heat exchanger, circulating the generated vapor through a steam turbine thereby causing the rotation of the steam turbine, and rotating a drive shaft of a generator coupled to the steam turbine thereby causing the generator to generate electricity. In at least one embodiment, the method further comprises the step of passing the vapor through a condenser after it has passed through the steam turbine. In at least one embodiment, the method further comprises the steps of circulating the heated liquid through a first heat exchanger stage and then through a second heat exchanger stage, and circulating the working fluid first through the second heat exchanger stage and then through the first heat exchanger stage. In at least one embodiment, the method further comprises the steps of circulating the heated liquid first through a first heat exchanger stage, second through a second heat exchanger stage, and then through a third heat exchanger stage, and circulating the working fluid first through the third heat exchanger stage, second through the second heat exchanger stage, and then through the first heat exchanger stage. In at least one embodiment, the method further comprises the steps of periodically measuring the temperature of the electrolytic heating subsystem, comparing the measured temperature with a preset temperature or temperature range, and modifying at least one process parameter of the electrolytic heating subsystem if the measured temperature is outside (lower or higher) of the preset temperature or temperature range. In at least one embodiment, the method further comprises the steps of periodically measuring the temperature of the working fluid, comparing the measured temperature with a preset temperature or temperature range, and modifying at least one process parameter of the electrolytic heating subsystem if the measured temperature is outside (lower or higher) of the preset temperature or temperature range. In at least one embodiment, the method further comprises the steps of periodically measuring the temperature of the liquid, comparing the measured temperature with a preset temperature or temperature range, and modifying at least one process parameter of the electrolytic heating subsystem if the measured temperature is outside (lower or higher) of the preset temperature or temperature range. In at least one embodiment, the step of performing electrolysis further comprises the steps of applying a low voltage to at least one pair of low voltage electrodes contained within the electrolysis tank of the electrolytic heating subsystem and applying a high voltage to at least one pair of high voltage electrodes contained within the electrolysis tank, wherein the low voltage and the high voltage are simultaneously pulsed. In at least one embodiment, the step of performing electrolysis further comprises the steps of applying a high voltage to at least one pair of high voltage electrodes contained within the electrolysis tank, the high voltage applying step further comprising the step of pulsing said high voltage, wherein at least one metal member is positioned between the high voltage anode(s) and the tank membrane and at least one other metal member is positioned between the high voltage cathode(s) and the tank membrane. In at least one embodiment, the method further comprises the step of generating a magnetic field within a portion of the electrolysis tank, wherein the magnetic field affects a heating rate corresponding to the electrolytic heating subsystem.

A further understanding of the nature and advantages of the present invention may be realized by reference to the remaining portions of the specification and the drawings.

### BRIEF DESCRIPTION OF THE DRAWINGS

FIG. 1 is an illustration of an exemplary embodiment of the invention;

FIG. 2 is an illustration of an alternate exemplary embodiment with multiple heating stages and a single electrolytic heating subsystem;

FIG. 3 is an illustration of an alternate exemplary embodiment with multiple heating stages and multiple electrolytic heating subsystems;

FIG. 4 is a detailed view of an embodiment of the electrolytic heating subsystem;

FIG. 5 is a detailed view of an alternate embodiment of the electrolytic heating subsystem shown in FIG. 4;

FIG. 6 is a detailed view of an alternate embodiment of the electrolytic heating subsystem shown in FIG. 4 utilizing an electromagnetic rate controller;

FIG. 7 is a detailed view of an alternate embodiment of the electrolytic heating subsystem shown in FIG. 5 utilizing an electromagnetic rate controller as shown in FIG. 6;

FIG. 8 is a detailed view of an alternate embodiment of the electrolytic heating subsystem shown in FIG. 6 utilizing a permanent magnet rate controller;

FIG. 9 is a detailed view of an alternate embodiment of the electrolytic heating subsystem shown in FIG. 7 utilizing a permanent magnet rate controller; and

FIG. 10 illustrates a mode of operation in which the electrolytic heating subsystem is periodically optimized.

### DESCRIPTION OF THE SPECIFIC EMBODIMENTS

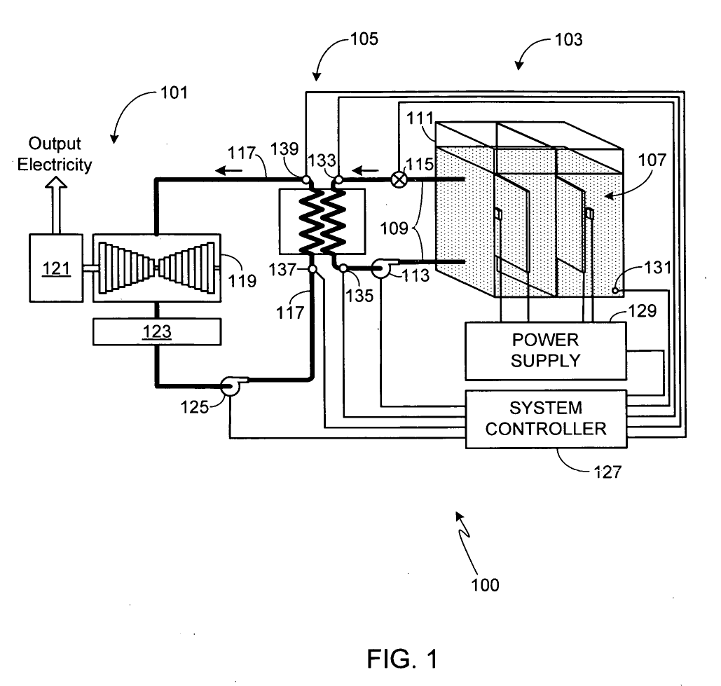

FIG. 1 is an illustration of an exemplary system 100 in accordance with the invention. System 100 is comprised of three primary subsystems; electric power generation subsystem 101, pulsed electrolytic heating subsystem 103, and heat exchanger subsystem 105. The system can be scaled to allow optimization for different power output requirements.

During operation, electrolytic heating subsystem 103 becomes very hot, the temperature dependent on the operating conditions of subsystem 103 (e.g., on/off cycling time, electrode size, input power, input frequency and pulse duration, etc.). Typically subsystem 103, and more specifically medium 107 within subsystem 103, is maintained during operation at a relatively high temperature, typically on the order of at least 150°-250° C., more preferably on the order of 250°-350° C., and still more preferably on the order of 350°-500° C. It some embodiments, the system is maintained at even higher temperatures.

During operation, the heated electrolysis medium is circulated through heat exchanger 105 via first circulation conduit 109, conduit 109 coupling the heat exchanger to electrolysis tank 111. It will be appreciated that tank 111 and conduit 109 are preferably designed to operate at high pressures, thus allowing the desired temperatures to be reached while maintaining fluid 107 in a fluid state. In the illustrated embodiment the heated working fluid is pumped through circulation conduit 109 and heat exchange subsystem 105 using a circulation pump 113. Pump 113 can be a single speed or a multi-speed pump and, in at least one embodiment, is used in conjunction with a control valve 115. Control valve 115 can be a variable flow valve or other type of valve. Pump 113, alone or in combination with valve 115, controls the flow of working fluid through conduit 109, and thus to an extent the temperature achieved in the heat exchanger.

Electric power generation subsystem 101 is coupled to heat exchange subsystem 105 by conduit 117. Within conduit 117 is a working fluid. Preferably the working fluid is water although other materials such as an organic fluid can also be used.

As the working fluid within conduit 117 passes through heat exchange subsystem 105 it is heated to a temperature above its boiling point, thereby creating vapor (e.g., steam). The vapor is circulated through a turbine 119, turbine 119 being either a single-stage or a multi-stage turbine. Although turbine 119 can be coupled to a variety of devices, thereby utilizing the rotary motion of the turbine to perform mechanical work, preferably turbine 119 is coupled to an electric generator 121, for example via direct linkage between the shaft of the turbine and the drive shaft of the generator. After the working fluid passes through turbine 119 it is cooled and condensed within a condenser 123. Preferably the working fluid is continually cycled through the steam process via circulation pump 125.

In a preferred embodiment of the invention, a system controller 127 controls the performance of the system by varying one or more operating parameters (i.e., process parameters) of electrolytic heating subsystem 103 to which it is attached via power supply 129. Varying operating parameters of power supply 129 and thus subsystem 103, for example cycling the subsystem on and off or varying other operational parameters as described further below, allows the subsystem to be operated at the desired temperature. Preferably at least one temperature monitor 131, coupled to subsystem 103, allows controller 127 to obtain feedback from the system as the operational parameters are varied. Preferably in addition to monitoring the temperature of subsystem 103, the temperature is monitored throughout system 100 thus allowing system operation to be monitored and optimized. For example, preferably the temperature of the electrolysis medium within conduit 109 is measured and monitored by system controller 127 using a pair of temperature monitors 133 and 135, both as the medium enters and as it exits heat exchange subsystem 105. Additionally, preferably the temperature of the working fluid within conduit 117 is measured and monitored by system controller 127 using a pair of temperature monitors 137 and 139, both as the working fluid enters and as it exits heat exchange subsystem 105. Additionally, in at least one preferred embodiment, the circulation pumps (e.g., pumps 113 and 125) and the control valves (e.g., flow valve 115) are also coupled to, and controlled by, controller 127. It will be appreciated that the system may also utilize other system monitors thus allowing complete system performance to be monitored and optimized. Exemplary parameters that can be monitored to provide system performance information include turbine rotation speed, steam temperature and pressure, generator output, etc.

It is often desirable to heat the working fluid in stages, this approach typically allowing improved optimization. In at least one preferred embodiment, the working fluid undergoes three heating stages; preheating, vaporization, and superheating. During the second stage, only the vapor is removed and sent on to the superheating stage during which additional heat can be added to the saturated vapor.

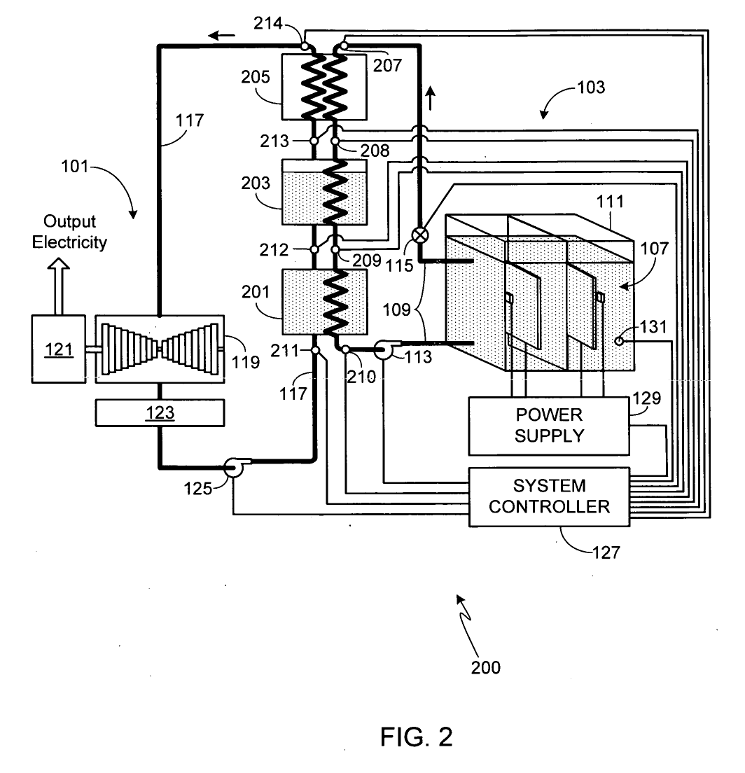

FIG. 2 schematically illustrates the application of the present invention to a three stage heating system. It will be appreciated that other configurations and/or different numbers of heating stages can also be used with the invention. In this embodiment the working fluid first passes through a pre-heater 201 (i.e., first heat exchanger stage). Preferably pre-heater 201 heats the working fluid up to a temperature below the boiling point of the working fluid. Next the working fluid passes through the central heater 203 (i.e., second heat exchanger stage). Heater 203 heats the working fluid to a temperature above its boiling point, thereby forming vapor. As the vapor remains in contact with the surface of the working fluid, the vapor is saturated and therefore unable to be superheated. Accordingly in at least one embodiment of the invention the saturated vapor is extracted from heat exchanger stage 203 and further heated within super-heater 205 (i.e., third heat exchanger stage). As illustrated in FIG. 2, the highest temperature electrolysis medium is used within super-heater 205. Due to the removal of heat from the electrolysis medium as it passes through each heating stage, the electrolysis medium is at it's lowest temperature as it passes through pre-heater stage 201. Although as previously noted, the degree of system monitoring can be varied, preferably in this embodiment the temperature of the electrolysis medium is monitored before and after each heating stage by temperature monitors 207-210. Similarly, in the preferred embodiment the temperature of the working fluid before and after each heating stage is monitored by monitors 211-214.

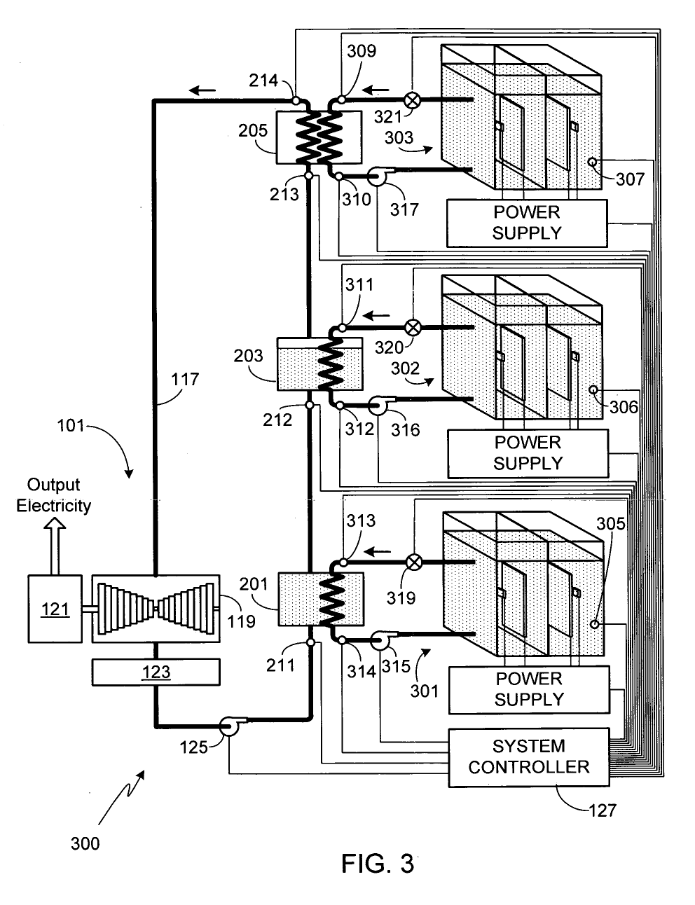

Multi-stage heating systems can also be used with multiple electrolytic heating subsystems as shown in the exemplary embodiment of FIG. 3. In system 300 pre-heater stage 201 is coupled to a first electrolytic heating subsystem 301, central heater stage 203 is coupled to a second electrolytic heating subsystem 302, and super-heater stage 205 is coupled to a third electrolytic heating subsystem 303. It will be appreciated that, if desired, multiple heating stages can be coupled to one or more of the multiple electrolytic heating subsystems, thus combining features illustrated in FIGS. 2 and 3. One advantage of using multiple electrolytic heating subsystems is that each of them can be optimized for the desired temperature for the corresponding heat exchanger (s). Preferably temperature monitors are included in each of the electrolytic heating subsystems (i.e., monitors 305-307) and at the inlet and outlet lines to each of the heat exchangers (i.e., monitors 309-314). The use of multiple electrolytic heating subsystems also adds to the number of circulation pumps (i.e., pumps 315-317) and control valves (i.e., valves 319-321) required to operate the system in accordance with the preferred mode.

Particulars of the electrolytic heating subsystem will now be provided. It will be appreciated that the following configurations can be used for systems utilizing a single electrolytic heating subsystem as shown in FIGS. 1 and 2, or for systems utilizing multiple electrolytic heating subsystems as shown in FIG. 3.

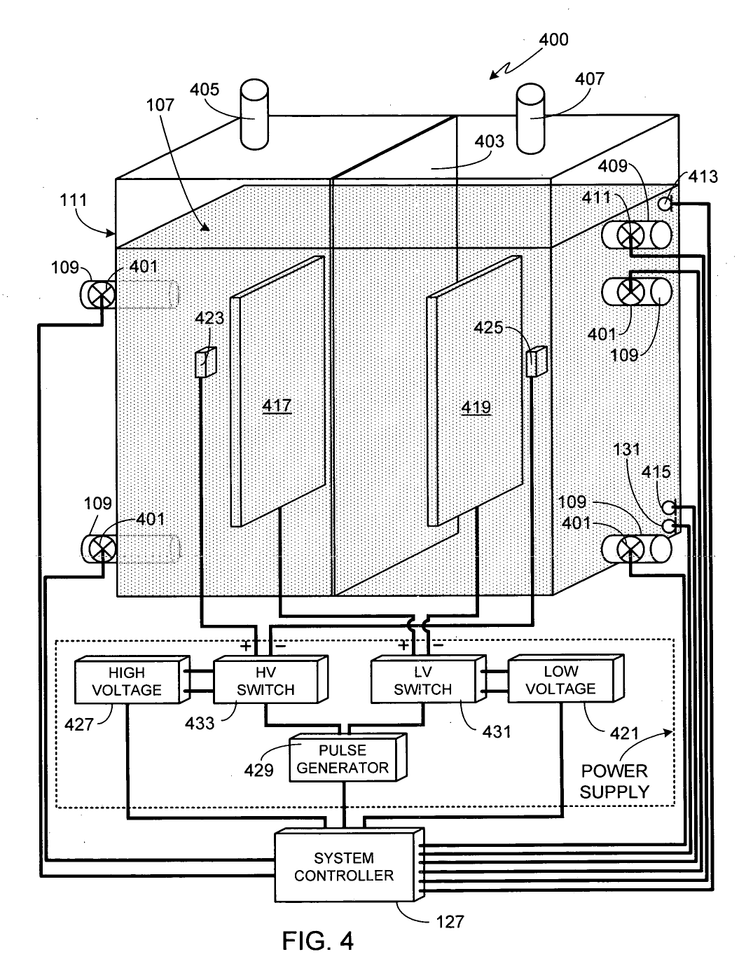

FIG. 4 is an illustration of a preferred embodiment of an electrolytic heating subsystem 400. Note that in FIGS. 4-9 only a portion of conduits 109 are shown. Additionally, while FIGS. 1-3 only show a single pair of conduits 109 for tank 111, preferably each region of the electrolysis tank includes an inlet and an outlet conduit 109 as shown in FIG. 4, thus insuring that the electrolysis medium circulated through the heat exchanger(s) is coupled to both regions. As previously noted, preferably a control valve is associated with conduit 109. In the embodiment shown in FIG. 4, each of the conduits 111 coupled to the two regions of the electrolysis tank 111 include a control valve 401, although it will be appreciated that the system can operate with fewer valves. Control valve or valves 401 are preferably coupled to controller 127 as shown.

Tank 111 is comprised of a non-conductive material. As with conduit 109 and conduit 117, tank 111 and all fittings and couplings associated with the tank or with either conduit are designed to accommodate the operational pressures of the subsystems. The size of tank 111 is primarily selected on the basis of the desired system output, i.e., the desired temperature as well as the expected flow rate of the electrolysis medium since the flow rate determines the rate at which heat is withdrawn from the electrolytic subsystem. Although tank 111 is shown as having a rectangular shape, it will be appreciated that the invention is not so limited and that tank 111 can utilize other shapes, for example cylindrical, square, irregularly-shaped, etc. Tank 111 is substantially filled with medium 107. In at least one preferred embodiment, liquid 107 is comprised of water, or more preferably water with an electrolyte, the electrolyte being an acid electrolyte, a base electrolyte, or a combination of an acid electrolyte and a base electrolyte. Exemplary electrolytes include potassium hydroxide and sodium hydroxide. The term “water” as used herein refers to water (H₂O), deuterated water (deuterium oxide or D₂O), tritiated water (tritium oxide or T₂O), semiheavy water (HDO), heavy oxygen water (H₂¹⁸O or H₂¹⁷O) or any other water containing an isotope of either hydrogen or oxygen, either singly or in any combination thereof (for example, a combination of H₂O and D₂O).

A typical electrolysis system used to decompose water into hydrogen and oxygen gases utilizes relatively high concentrations of electrolyte. Subsystem 103, however, has been found to work best with relatively low electrolyte concentrations, thereby maintaining a relatively high initial water resistivity. Preferably the water resistivity prior to the addition of an electrolyte is on the order of 1 to 28 megohms. Preferably the concentration of electrolyte is in the range of 0.05 percent to 10 percent by weight, more preferably the concentration of electrolyte is in the range of 0.05 percent to 2.0 percent by weight, and still more preferably the concentration of electrolyte is in the range of 0.1 percent to 0.5 percent by weight.

Separating tank 111 into two regions is a membrane 403. Membrane 403 permits ion/electron exchange between the two regions of tank 111. Assuming medium 107 is water, as preferred, small amounts of hydrogen and oxygen are produced during operation. Accordingly membrane 403 also keeps the oxygen and hydrogen bubbles produced during electrolysis separate, thus minimizing the risk of inadvertent recombination of the two gases. Exemplary materials for membrane 403 include, but are not limited to, polypropylene, tetrafluoroethylene, asbestos, etc. Preferably tank 111 also includes a pair of gas outlets 405 and 407, corresponding to the two regions of tank 111. The volume of gases produced by the process can either be released, through outlets 405 and 407, into the atmosphere in a controlled manner or they can be collected and used for other purposes.

As previously noted, since the electrolytic heating subsystem is designed to reach relatively high temperatures, the materials comprising tank 111, membrane 403 and other subsystem components are selected on the basis of their ability to withstand the expected temperatures and pressures. As previously noted, the subsystem is intended to operate at relatively high temperatures, typically at least 150°-250° C., more preferably on the order of 250°-350° C., and still more preferably on the order of 350°-500° C. Accordingly, it will be understood that the choice of materials for the subsystem components and the design of the subsystem (e.g., tank wall thicknesses, fittings, etc.) will vary, depending upon the intended subsystem operational parameters, primarily temperature and pressure.

Replenishment of medium 107 can be through one or more dedicated lines. FIG. 4 shows a portion of one such conduit, conduit 409, coupled to one of the regions of tank 111. Alternately, a replenishment conduit can be coupled to both regions of tank 111 (not shown). Alternately, the replenishment conduit can be coupled to the one or more of conduits 109. Although medium replenishment can be performed manually, preferably replenishment is performed automatically, for example using system controller 127 and flow valve 411 within line 409. Replenishment can be performed periodically or continually at a very low flow rate. If periodic replenishment is used, it can either be based on the period of system operation, for example replenishing the system with a predetermined volume of medium after a preset number of hours of operation, or based on the volume of medium within tank 111, the volume being provided to controller 127 using a level monitor 413 within the tank or other means. In at least one preferred embodiment system controller 127 is also coupled to a monitor 415, monitor 415 providing either the pH or the resistivity of liquid 107 within the electrolysis tank, thereby providing means for determining when additional electrolyte needs to be added. In at least one embodiment and as previously noted, preferably system controller 127 is also coupled to a temperature monitor 131, monitor 131 providing the temperature of the electrolysis medium.

In at least one embodiment of the electrolytic heating subsystem, two types of electrodes are used, each type of electrode being comprised of one or more electrode pairs with each electrode pair including at least one cathode (i.e., a cathode coupled electrode) and at least one anode (i.e., an anode coupled electrode). All cathodes, regardless of the type, are kept in one region of tank 111 while all anodes, regardless of the type, are kept in the other tank region, the two tank regions separated by membrane 403. In the embodiment illustrated in FIG. 4, each type of electrode includes a single pair of electrodes.

The first type of electrodes, electrodes 417/419, are coupled to a low voltage source 421. The second type of electrodes, electrodes 423/425, are coupled to a high voltage source 427. In the illustrations and as used herein, voltage source 421 is labeled as a ‘low’ voltage source not because of the absolute voltage produced by the source, but because the output of voltage source 421 is maintained at a lower output voltage than the output of voltage source 427. Preferably and as shown, the individual electrodes of each pair of electrodes are parallel to one another; i.e., the face of electrode 417 is parallel to the face of electrode 419 and the face of electrode 423 is parallel to the face of electrode 425. It should be appreciated, however, that such an electrode orientation is not required.

In one preferred embodiment, electrodes 417/419 and electrodes 423/425 are comprised of titanium. In another preferred embodiment, electrodes 417/419 and electrodes 423/425 are comprised of stainless steel. It should be appreciated, however, that other materials can be used and that the same material does not have to be used for both the low and high voltage electrodes. Additionally, the same material does not have to be used for both the anode(s) and the cathode(s) of the low voltage electrodes, nor does the same material have to be used for both the anode(s) and the cathode(s) of the high voltage electrodes. In addition to titanium and stainless steel, other exemplary materials that can be used for the low voltage and high voltage electrodes include, but are not limited to, copper, iron, steel, cobalt, manganese, zinc, nickel, platinum, palladium, aluminum, lithium, magnesium, boron, carbon, graphite, carbon-graphite, metal hydrides and alloys of these materials. Preferably the surface area of the faces of the low voltage electrodes (e.g., electrode 417 and electrode 419) cover a large percentage of the cross-sectional area of tank 111, typically on the order of at least 40 percent of the cross-sectional area of tank 111, and more typically between approximately 70 percent and 90 percent of the cross-sectional area of tank 111. Preferably the separation between the low voltage electrodes (e.g., electrodes 417 and 419) is between 0.1 millimeters and 15 centimeters. In at least one embodiment the separation between the low voltage electrodes is between 0.1 millimeters and 1 millimeter. In at least one other embodiment the separation between the low voltage electrodes is between 1 millimeter and 5 millimeters. In at least one other embodiment the separation between the low voltage electrodes is between 5 millimeters and 2 centimeters. In at least one other embodiment the separation between the low voltage electrodes is between 5 centimeters and 8 centimeters. In at least one other embodiment the separation between the low voltage electrodes is between 10 centimeters and 12 centimeters.

In the illustrated embodiment, electrodes 423/425 are positioned outside of the planes containing electrodes 417/419. In other words, the separation distance between electrodes 423 and 425 is greater than the separation distance between electrodes 417 and 419 and both low voltage electrodes are positioned between the planes containing the high voltage electrodes. The high voltage electrodes may be larger, smaller or the same size as the low voltage electrodes.

As previously noted, the voltage applied to the high voltage electrodes is greater than that applied to the low voltage electrodes. Preferably the ratio of the high voltage to the low voltage applied to the high voltage and low voltage electrodes, respectively, is at least 5:1, more preferably the ratio is between 5:1 and 100:1, still more preferably the ratio is between 5:1 and 33:1, and even still more preferably the ratio is between 5:1 and 20:1. Preferably the high voltage generated by source 427 is within the range of 50 volts to 50 kilovolts, more preferably within the range of 100 volts to 5 kilovolts, and still more preferably within the range of 500 volts to 2.5 kilovolts. Preferably the low voltage generated by source 421 is within the range of 3 volts to 1500 volts, more preferably within the range of 12 volts to 750 volts, still more preferably within the range of 24 volts to 500 volts, and yet still more preferably within the range of 48 volts to 250 volts.

Rather than continually apply voltage to the electrodes, sources 421 and 427 are pulsed, preferably at a frequency of between 50 Hz and 1 MHz, more preferably at a frequency of between 100 Hz and 10 kHz, and still more preferably at a frequency of between 150 Hz and 7 kHz. The pulse width (i.e., pulse duration) is preferably between 0.01 and 75 percent of the time period defined by the frequency, and more preferably between 0.1 and 50 percent of the time period defined by the frequency, and still more preferably between 0.1 and 25 percent of the time period defined by the frequency. Thus, for example, for a frequency of 150 Hz, the pulse duration is preferably in the range of 0.67 microseconds to 5 milliseconds, more preferably in the range of 6.67 microseconds to 3.3 milliseconds, and still more preferably in the range of 6.67 microseconds to 1.7 milliseconds. Alternately, for example, for a frequency of 1 kHz, the pulse duration is preferably in the range of 0.1 microseconds to 0.75 milliseconds, more preferably in the range of 1 microsecond to 0.5 milliseconds, and still more preferably in the range of 1 microsecond to 0.25 milliseconds. Additionally, the voltage pulses are applied simultaneously to the high voltage and low voltage electrodes via sources 421 and 427, respectively. In other words, the voltage pulses applied to high voltage electrodes 423/425 coincide with the pulses applied to low voltage electrodes 417/419. Although voltage sources 421 and 427 can include internal means for pulsing the respective outputs from each source, preferably an external pulse generator 429 controls a pair of switches, i.e., low voltage switch 431 and high voltage switch 433 which, in turn, control the output of voltage sources 421 and 427 as shown, and as described above.

In at least one preferred embodiment, the frequency and/or pulse duration and/or low voltage and/or high voltage can be changed by system controller 127 during system operation, thus allowing the operation of the electrolytic heating subsystem to be controlled. For example, in the configuration shown in FIG. 4, low voltage power supply 421, high voltage power supply 427 and pulse generator 429 are all connected to system controller 127, thus allowing controller 127 to control the amount of heat generated by the electrolytic heating subsystem. It will be appreciated that both power supplies and the pulse generator do not have to be connected to system controller 127 to provide heat generation control. For example, only one of the power supplies and/or the pulse generator can be connected to controller 127.

As will be appreciated by those of skill in the art, there are numerous minor variations of the electrolytic heating subsystem described above and shown in FIG. 4 that can be used with the invention. For example, and as previously noted, alternate configurations can utilize tanks of different size and/or shape, different electrolytic solutions, and a variety of different electrode configurations and materials. Exemplary alternate electrode configurations include, but are not limited to, multiple low voltage cathodes, multiple low voltage anodes, multiple high voltage cathodes, multiple high voltage anodes, multiple low voltage electrode pairs combined with multiple high voltage electrode pairs, electrodes of varying size or shape (e.g., cylindrical, curved, etc.), and electrode pairs of varying orientation (e.g., non-parallel faces, pairs in which individual electrodes are not positioned directly across from one another, etc.). Additionally, alternate configurations can utilize a variety of input powers, pulse frequencies and pulse durations as previously noted.

In an exemplary embodiment of the electrolytic heating subsystem, a cylindrical chamber measuring 125 centimeters long with an inside diameter of 44 centimeters and an outside diameter of 50 centimeters was used. The tank contained 175 liters of water, the water including a potassium hydroxide (KOH) electrolyte at a concentration of 0.1% by weight. The low voltage electrodes were 75 centimeters by 30 centimeters by 0.5 centimeters and had a separation distance of approximately 10 centimeters. The high voltage electrodes were 3 centimeters by 2.5 centimeters by 0.5 centimeters and had a separation distance of approximately 32 centimeters. Both sets of electrodes were comprised of titanium. The pulse frequency was maintained at 150 Hz and the pulse duration was initially set to 260 microseconds and gradually lowered to 180 microseconds during the course of a 4 hour run. The low voltage supply was set to 50 volts, drawing a current of between 5.5 and 7.65 amps, and the high voltage supply was set to 910 volts, drawing a current of between 2.15 and 2.48 amps. The initial temperature was 28° C. and monitored continuously with a pair of thermocouples, one in each side of the tank. After conclusion of the 4 hour run, the temperature of the tank fluid had increased to 67° C.

Illustrating the correlation between electrode size and heat production efficiency, the high voltage electrodes of the previous test were replaced with larger electrodes, the larger electrodes measuring 9.5 centimeters by 5 centimeters by 0.5 centimeters, thus providing approximately 6.3 times the surface area of the previous high voltage electrodes. The larger electrodes, still operating at a voltage of 910 volts, drew a current of between 1.73 and 1.9 amps. The low voltage supply was again set at 50 volts, in this run the low voltage electrodes drawing between 0.6 and 1.25 amps. Although the pulse frequency was still maintained at 150 Hz, the pulse duration was lowered from an initial setting of 60 microseconds to 15 microseconds. All other operating parameters were the same as in the previous test. In this test, during the course of a 5 hour run, the temperature of the tank fluid increased from 28° C. to 69° C. Given the shorter pulses and the lower current, this test with the larger high voltage electrodes exhibited a heat production efficiency approximately 8 times that exhibited in the previous test.

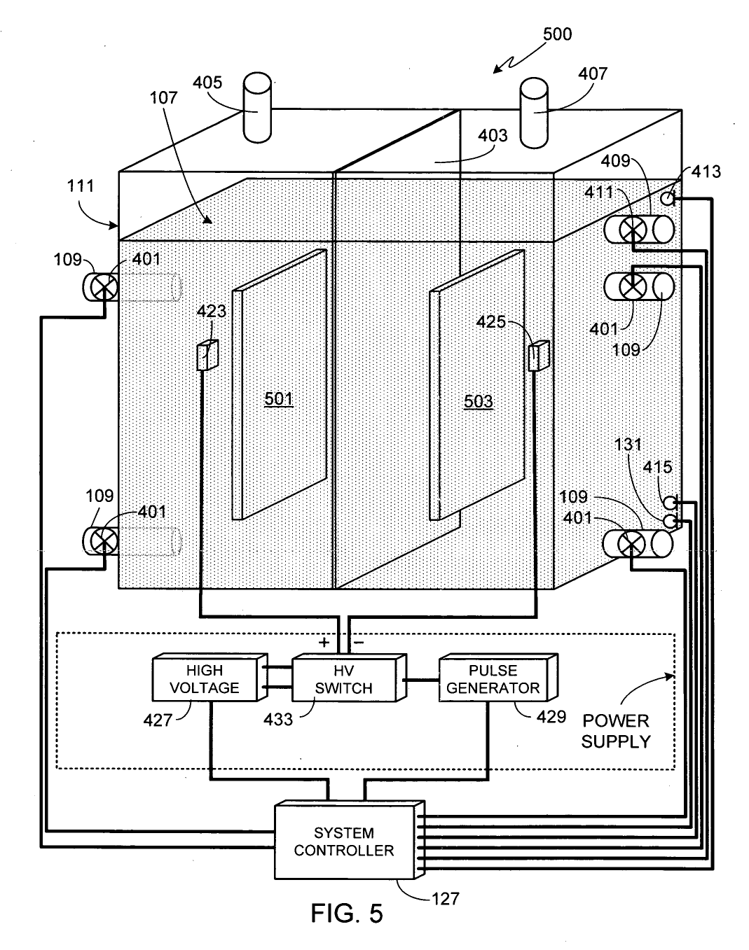

FIG. 5 is an illustration of a second exemplary embodiment of the electrolytic heating subsystem, this embodiment using a single type of electrodes. Subsystem 500 is basically the same as subsystem 400 shown in FIG. 4 with the exception that low voltage electrodes 417/419 have been replaced with a pair of metal members 501/503; metal member 501 interposed between high voltage electrode 423 and membrane 403 and metal member 503 interposed between high voltage electrode 425 and membrane 403. The materials comprising metal members 501/503 are the same as those of the low voltage electrodes. Preferably the surface area of the faces of members 501 and 503 is a large percentage of the cross-sectional area of tank 111, typically on the order of at least 40 percent, and often between approximately 70 percent and 90 percent of the cross-sectional area of tank 111. Preferably the separation between members 501 and 503 is between 0.1 millimeters and 15 centimeters. In at least one embodiment the separation between the metal members is between 0.1 millimeters and 1 millimeter. In at least one other embodiment the separation between the metal members is between 1 millimeter and 5 millimeters. In at least one other embodiment the separation between the metal members is between 5 millimeters and 2 centimeters. In at least one other embodiment the separation between the metal members is between 5 centimeters and 8 centimeters. In at least one other embodiment the separation between the metal members is between 10 centimeters and 12 centimeters. The preferred ranges for the size of the high voltage electrodes as well as the high voltage power, pulse frequency and pulse duration are the same as in the exemplary subsystem shown in FIG. 4 and described above.

In a test of the exemplary embodiment of the electrolytic heating subsystem using metal members in place of low voltage electrodes, the same cylindrical chamber and electrolyte-containing water was used as in the previous test. The metal members were 75 centimeters by 30 centimeters by 0.5 centimeters and had a separation distance of approximately 10 centimeters. The high voltage electrodes were 3 centimeters by 2.5 centimeters by 0.5 centimeters and had a separation distance of approximately 32 centimeters. The high voltage electrodes and the metal members were fabricated from stainless steel. The pulse frequency was maintained at 150 Hz and the pulse duration was initially set to 250 microseconds and gradually lowered to 200 microseconds during the course of a 2 hour run. The high voltage supply was set to 910 volts, drawing a current of between 2.21 and 2.45 amps. The initial temperature was 30° C. and monitored continuously with a pair of thermocouples, one in each side of the tank. After conclusion of the 2 hour run, the temperature of the tank fluid had increased to 60° C.

As with the previously described set of tests, the correlation between electrode size and heat production efficiency was demonstrated by replacing the high voltage electrodes with larger electrodes measuring 9.5 centimeters by 5 centimeters by 0.5 centimeters. The larger electrodes, still operating at a voltage of 910 volts, drew a current of between 1.6 and 1.94 amps. The pulse frequency was still maintained at 150 Hz, however, the pulse duration was lowered from an initial setting of 90 microseconds to 25 microseconds. All other operating parameters were the same as in the previous test. In this test during the course of a 6 hour run, the temperature of the tank fluid increased from 23° C. to 68° C., providing an increase in heat production efficiency of approximately 3 times over that exhibited in the previous test.

As with the previous exemplary embodiment, it will be appreciated that there are numerous minor variations of the electrolytic heating subsystem described above and shown in FIG. 5 that can be used with the invention. For example, and as previously noted, alternate configurations can utilize tanks of different size and/or shape, different electrolytic solutions, and a variety of different electrode/metal member configurations and materials. Exemplary alternate electrode/metal member configurations include, but are not limited to, multiple sets of metal members, multiple high voltage cathodes, multiple high voltage anodes, multiple sets of metal members combined with multiple high voltage cathodes and anodes, electrodes/metal members of varying size or shape (e.g., cylindrical, curved, etc.), and electrodes/metal members of varying orientation (e.g., non-parallel faces, pairs in which individual electrodes are not positioned directly across from one another, etc.). Additionally, alternate configurations can utilize a variety of input powers, pulse frequencies and pulse durations.

In at least one preferred embodiment of the invention, the electrolytic heating subsystem uses a reaction rate controller to help achieve optimal performance of the heating subsystem(s). The rate controller operates by generating a magnetic field within the electrolysis tank, either within the region between the high voltage cathode(s) and the low voltage cathode(s) or metal member(s), or within the region between the high voltage anode(s) and the low voltage anode(s) or metal member(s), or both regions. The magnetic field can either be generated with an electromagnetic coil or coils, or with one or more permanent magnets. The benefit of using electromagnetic coils is that the intensity of the magnetic field generated by the coil or coils can be varied by controlling the current supplied to the coil(s), thus providing a convenient method of controlling the reaction rate.

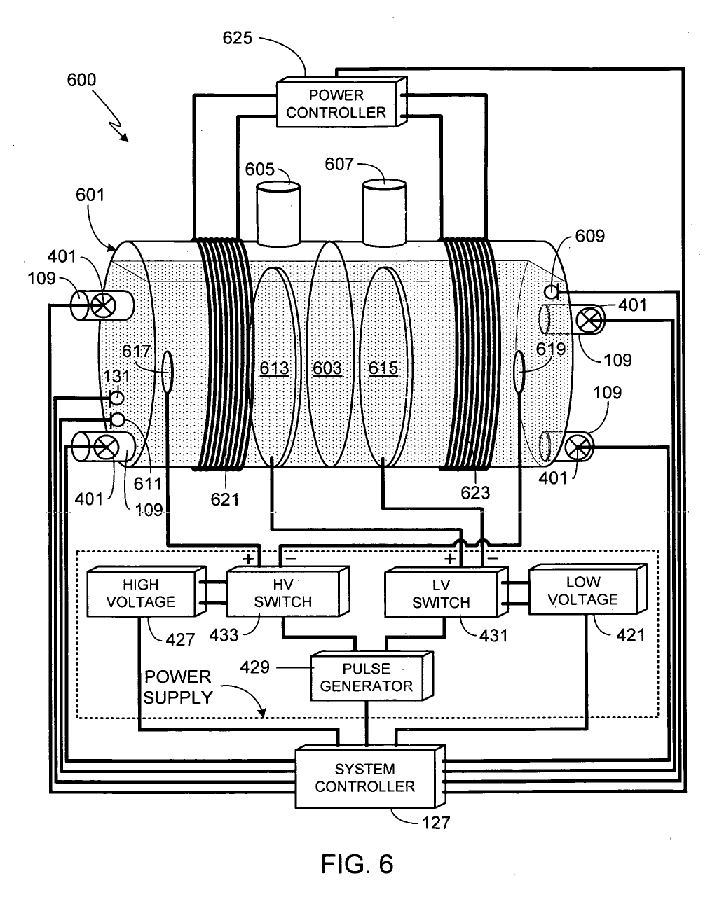

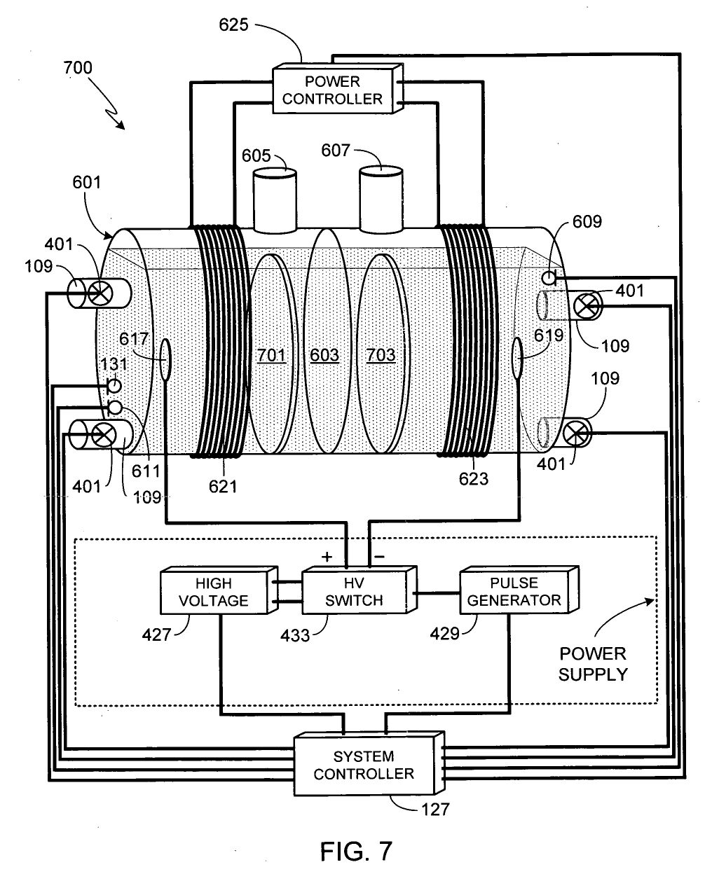

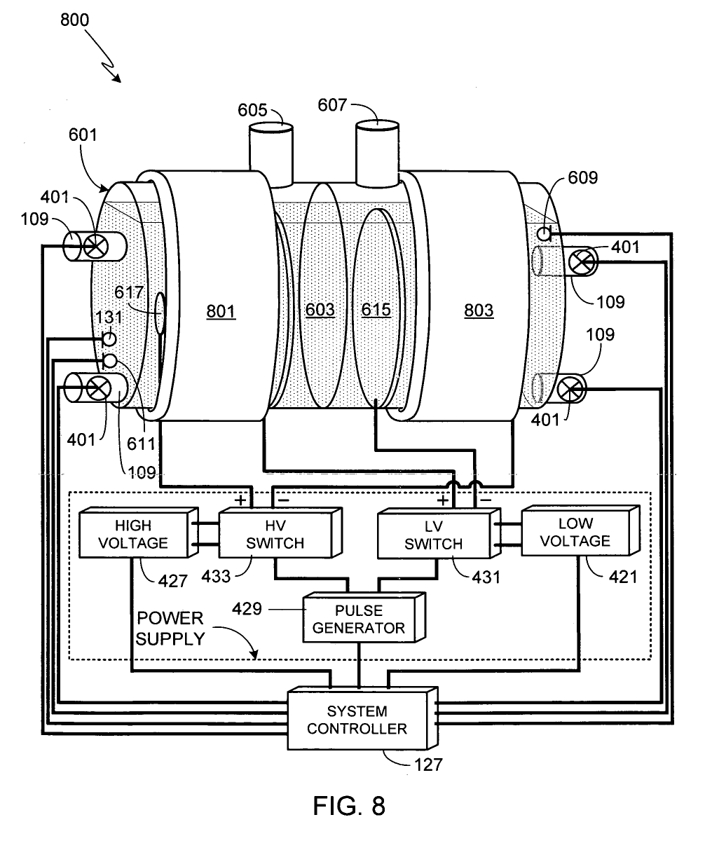

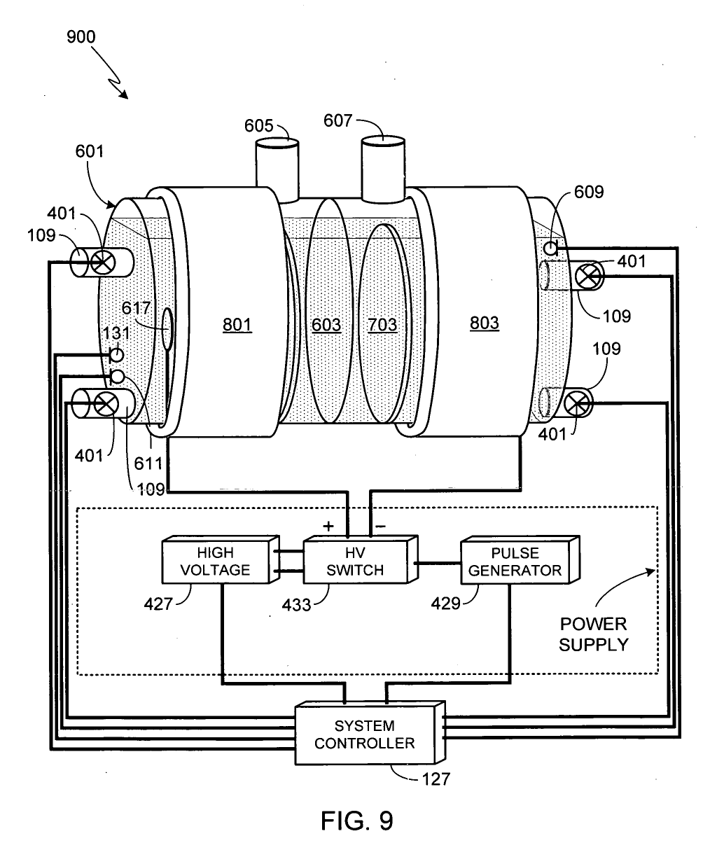

FIG. 6 provides an exemplary embodiment of an electrolytic heating subsystem 600 that includes an electromagnetic rate controller. It should be understood that the electromagnetic rate controller shown in FIGS. 6 and 7, or the rate controller using permanent magnets shown in FIGS. 8 and 9, is not limited to a specific tank/electrode configuration. For example, electrolysis tank 601 of system 600 is cylindrically-shaped although the tank could utilize other shapes such as the rectangular shape of tank 111. As in the previous embodiments, the electrolytic heating subsystem includes a membrane (e.g., membrane 603) separating the tank into two regions, a pair of gas outlets (e.g., outlets 605/607), inlet and outlet conduits 109 (one pair per region in the exemplary embodiment illustrated in FIG. 6) to allow the electrolysis medium to be circulated through the heat exchanger, and preferably flow control valves (e.g., valves 401) coupled to the system controller 127. A separate replenishment conduit can be used as previously illustrated in FIGS. 4 and 5, although such a conduit is not shown in FIGS. 6-9, thereby simplifying the illustration. Preferably the system also includes a water level monitor (e.g., monitor 609), a pH or resistivity monitor (e.g., monitor 611), and a temperature monitor 125. This embodiment, similar to the one shown in FIG. 4, utilizes both low voltage and high voltage electrodes. Specifically, subsystem 600 includes a pair of low voltage electrodes 613/615 and a pair of high voltage electrodes 617/619.

In the electrolytic heating subsystem illustrated in FIG. 6, a magnetic field of controllable intensity is generated between the low voltage and high voltage electrodes within each region of tank 601. Although a single electromagnetic coil can generate fields within both tank regions, in the illustrated embodiment the desired magnetic fields are generated by a pair of electromagnetic coils 621/623. As shown, electromagnetic coil 621 generates a magnetic field between the planes containing low voltage electrode 613 and high voltage electrode 617 and electromagnetic coil 623 generates a magnetic field between the planes containing low voltage electrode 615 and high voltage electrode 619. Electromagnetic coils 621/623 are coupled to a controller 625 which is used to vary the current through coils 621/623, thus allowing the strength of the magnetic field generated by the electromagnetic coils to be varied as desired. As a result, the rate of the reaction driven by the electrolysis system, and thus the amount of heat generated by the subsystem, can be controlled. In particular, increasing the magnetic field generated by coils 621/623 decreases the reaction rate. Accordingly, a maximum reaction rate is achieved with no magnetic field while the minimum reaction rate is achieved by imposing the maximum magnetic field. It will be appreciated that the exact relationship between the magnetic field and the reaction rate depends on a variety of factors including reaction strength, electrode composition and configuration, voltage/pulse frequency/pulse duration applied to the electrodes, electrolyte concentration, and achievable magnetic field, the last parameter dependent primarily upon the composition of the coils, the number of coil turns, and the current available from controller 625.

Although the subsystem embodiment shown in FIG. 6 utilizes coils that are interposed between the low voltage electrode and the high voltage electrode planes, it will be appreciated that the critical parameter is to configure the system such that there is a magnetic field, preferably of controllable intensity, between the low voltage and high voltage electrode planes. Thus, for example, if the coils extend beyond either, or both, the plane containing the low voltage electrode(s) and the plane controlling the high voltage electrode(s), the system will still work as the field generated by the coils includes the regions between the low voltage and high voltage electrodes. Additionally it will be appreciated that although the embodiment shown in FIG. 6 utilizes a single controller 625 coupled to both coils, the system can also utilize separate controllers for each coil (not shown). Similarly, while the illustrated subsystem utilizes dual coils, the invention can also use a single coil to generate a single field which affects both tank regions, or primarily affects a single tank region. Additionally it will be appreciated that the electromagnetic coils do not have to be mounted to the exterior surface of the tank as shown in FIG. 6. For example, the electromagnetic coils can be integrated within the walls of the tank, or mounted within the tank. By mounting the electromagnetic coils within, or outside, of the tank walls, coil deterioration from electrolytic erosion is minimized.

The magnetic field rate controller is not limited to use with electrolytic heating subsystems employing both low and high voltage electrodes. For example, the electromagnetic rate controller subsystem can be used with embodiments using high voltage electrodes and metal members as described above and shown in the exemplary embodiment of FIG. 5. FIG. 7 is an illustration of an exemplary embodiment based on the embodiment shown in FIG. 6, replacing low voltage electrodes 613/615 with metal members 701/703, respectively. As with the electromagnetic rate controller used with the dual voltage system, it will be appreciated that configurations using high voltage electrodes and metal members can utilize internal electromagnetic coils, electromagnetic coils mounted within the tank walls, and electromagnetic coils mounted outside of the tank walls. Additionally, and as previously noted, the electromagnetic rate controller is not limited to a specific tank and/or electrode configuration.

As previously noted, although electromagnetic coils provide a convenient means for controlling the intensity of the magnetic field applied to the reactor, permanent magnets can also be used with the electrolytic heating subsystem of the invention, for example when the magnetic field does not need to be variable. FIGS. 8 and 9 illustrate embodiments based on the configurations shown in FIGS. 6 and 7, but replacing coils 621 and 623 with permanent magnets 801 and 803, respectively. Note that in the view of FIG. 8, only a portion of electrode 613 is visible while none of electrode 619 is visible. Similarly in the view of FIG. 9, only a portion of metal member 701 is visible while none of electrode 619 is visible.

In at least one mode of operation, the system controller is configured to adjust the operating parameters of the electrolytic heating subsystem during operation, for example based on the temperature of the electrolysis medium. This type of control can be used, for example, to insure that the temperature of the electrolytic heating subsystem remains within a preset range, even if the system output varies with age. Typically this type of process modification occurs periodically; for example the system can be configured to execute a system performance self-check every 30 minutes or at some other time interval.

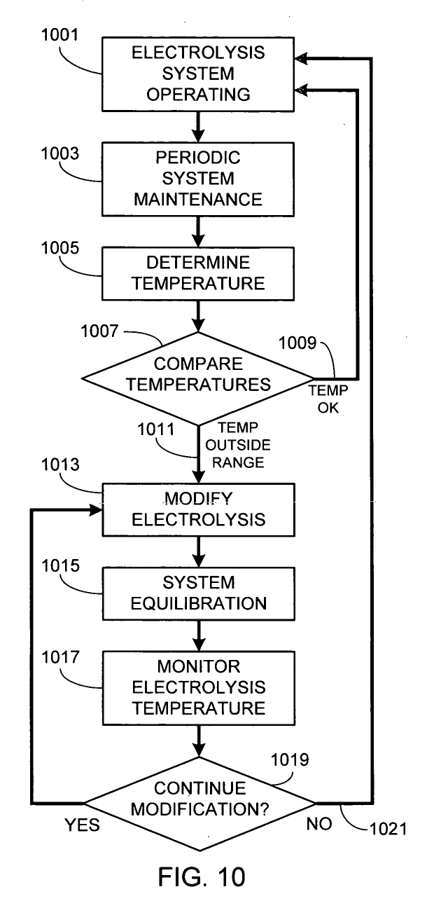

FIG. 10 illustrates a preferred method of modifying the output of the electrolytic heating subsystem. As shown, during system operation (step 1001) the system controller periodically performs a self-check (step 1003). The first step of the self-check process is to determine the temperature of the selected region of the system (step 1005). As previously noted, typically the system is configured to perform the self-check process on the basis of the monitored temperature of the electrolysis fluid, although the temperature of other regions/components can also be used. The measured temperature is then compared to a preset temperature or temperature range (step 1007). If the temperature is acceptable (step 1009), for example within the preset temperature range, the system simply goes back to standard operation until the system determines that it is time for another system check. If the measured temperature is unacceptable (step 1011), for example if it falls outside of the preset range, the electrolysis process is modified (step 1013). During the electrolysis process modification step, i.e., step 1013, one or more process parameters are varied. Exemplary process parameters include pulse duration, pulse frequency, system power cycling, electrode voltage, and, if the system includes an electromagnetic rate control system, the intensity of the magnetic field. Preferably during the electrolysis modification step, the system controller modifies the process in accordance with a series of pre-programmed changes, for example altering the pulse duration in 10 microsecond steps until the desired temperature is reached. Since varying the electrolysis process does not have an immediate affect on the monitored temperature, preferably after making a system change, a period of time is allowed to pass (step 1015) before determining if further process modification is required, thus allowing the system to reach equilibrium, or close to equilibrium. During the process, the system controller continues to monitor the temperature of the selected region/material (step 1017) and compare that temperature to the preset temperature/temperature range in order to determine if further modification is required (step 1019). Once the temperature reaches an acceptable level (step 1021), the system goes back to standard operation.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A power generating system comprising:
an electrolytic heating subsystem comprising:
an electrolysis tank;
a liquid within said electrolysis tank, wherein said liquid includes at least one of water, deuterated water, tritiated water, semiheavy water, heavy oxygen water, water containing an isotope of hydrogen, and water containing an isotope of oxygen;
a membrane separating said electrolysis tank into a first region and a second region;
at least one pair of low voltage electrodes contained within said electrolysis tank, wherein each pair of said at least one pair of low voltage electrodes includes an anode and a cathode;
at least one pair of high voltage electrodes contained within said electrolysis tank, wherein each pair of said at least one pair of high voltage electrodes includes an anode and a cathode, wherein said anodes of said at least one pair of low voltage electrodes and said anodes of said at least one pair of high voltage electrodes are contained within said first region, wherein said cathodes of said at least one pair of low voltage electrodes and said cathodes of said at least one pair of high voltage electrodes are contained within said second region, and wherein a first separation distance corresponding to the distance between the electrodes of each pair of high voltage electrodes is greater than a second separation distance corresponding to the distance between the electrodes of each pair of low voltage electrodes;
a low voltage source with a first output voltage electrically connected to said at least one pair of low voltage electrodes;
a high voltage source with a second output voltage electrically connected to said at least one pair of high voltage electrodes, wherein said second output voltage is higher than said first output voltage; and
a pulse generator coupled to said low voltage source and to said high voltage source, wherein said pulse generator simultaneously pulses both said low voltage source and said high voltage source voltage at a specific frequency and with a specific pulse duration;
a heat exchanger;
a first conduit coupling said electrolysis tank to said heat exchanger, wherein said first conduit contains said liquid;
a steam turbine;
a second conduit coupling said steam turbine to said heat exchanger, wherein said second conduit contains a working fluid, and wherein working fluid vapor formed as said working fluid passes through said heat exchanger is passed through said steam turbine; and
an electric generator coupled to said steam turbine.

2. The power generating system of claim 1, further comprising a condenser coupled to said second conduit, wherein said working fluid vapor passing through said steam turbine is cooled and condensed within said condenser.

3. The power generating system of claim 1, wherein said heat exchanger is comprised of at least a first heat exchanger stage and a second heat exchanger stage, wherein said second conduit is serially coupled first to said first heat exchanger stage and second to said second heat exchanger stage, and wherein said first conduit is serially coupled first to said second heat exchanger stage and second to said first heat exchanger stage.

4. The power generating system of claim 1, further comprising a second electrolytic heating subsystem, wherein said heat exchanger is comprised of at least a first heat exchanger stage and a second heat exchanger stage, wherein said second conduit is serially coupled first to said first heat exchanger stage and second to said second heat exchanger stage, wherein said first conduit is coupled to said first heat exchanger stage, and wherein said second electrolytic heating subsystem is coupled to said second heat exchanger stage.

5. The power generating system of claim 1, further comprising a system controller coupled to at least one of said low voltage source, said high voltage source, and said pulse generator.

6. The power generating system of claim 1, wherein each low voltage cathode is comprised of a first material, wherein each low voltage anode is comprised of a second material, wherein each high voltage cathode is comprised of a third material, wherein each high voltage anode is comprised of a fourth material, and wherein said first, second, third and fourth materials are selected from the group consisting of titanium, stainless steel, copper, iron, steel, cobalt, manganese, zinc, nickel, platinum, palladium, aluminum, lithium, magnesium, boron, carbon, graphite, carbon-graphite, and metal hydrides and alloys of titanium, stainless steel, copper, iron, steel, cobalt, manganese, zinc, nickel, platinum, palladium, aluminum, lithium, magnesium, boron, carbon, graphite, carbon-graphite, and metal hydrides.

7. The power generating system of claim 1, further comprising an electromagnetic rate controller subsystem, said electromagnetic rate controller subsystem comprising:
at least one electromagnetic coil, said at least one electromagnetic coil generating a controllable magnetic field within a portion of said electrolysis tank; and
means for controlling magnetic field intensity of said magnetic field, wherein said controlling means is coupled to said at least one electromagnetic coil.

8. The power generating system of claim 1, further comprising at least one permanent magnet, said at least one permanent magnet generating a magnetic field within a portion of said electrolysis tank.

9. A power generating system comprising:
an electrolytic heating subsystem comprising:
an electrolysis tank;
a liquid within said electrolysis tank, wherein said liquid includes at least one of water, deuterated water, tritiated water, semiheavy water, heavy oxygen water, water containing an isotope of hydrogen, and water containing an isotope of oxygen;
a membrane separating said electrolysis tank into a first region and a second region;
at least one pair of high voltage electrodes contained within said electrolysis tank, wherein each pair of said at least one pair of high voltage electrodes includes an anode and a cathode, wherein said anodes of said at least one pair of high voltage electrodes are contained within said first region, and wherein said cathodes of said at least one pair of high voltage electrodes are contained within said second region;
a plurality of metal members contained within said electrolysis tank, wherein at least a first metal member of said plurality of metal members is contained within said first region and interposed between said anodes of said at least one pair of high voltage electrodes and said membrane, and wherein at least a second metal member of said plurality of metal members is contained within said second region and interposed between said cathodes of said at least one pair of high voltage electrodes and said membrane;
a high voltage source with an output voltage electrically connected to said at least one pair of high voltage electrodes; and
a pulse generator coupled to said high voltage source, wherein said pulse generator pulses said high voltage source voltage at a specific frequency and with a specific pulse duration;
a heat exchanger;
a first conduit coupling said electrolysis tank to said heat exchanger, wherein said first conduit contains said liquid;
a steam turbine;
a second conduit coupling said steam turbine to said heat exchanger, wherein said second conduit contains a working fluid, and wherein working fluid vapor formed as said working fluid passes through said heat exchanger is passed through said steam turbine; and
an electric generator coupled to said steam turbine.

10. The power generating system of claim 9, further comprising a condenser coupled to said second conduit, wherein said working fluid vapor passing through said steam turbine is cooled and condensed within said condenser.

11. The power generating system of claim 9, wherein said heat exchanger is comprised of at least a first heat exchanger stage and a second heat exchanger stage, wherein said second conduit is serially coupled first to said first heat exchanger stage and second to said second heat exchanger stage, and wherein said first conduit is serially coupled first to said second heat exchanger stage and second to said first heat exchanger stage.

12. The power generating system of claim 9, further comprising a second electrolytic heating subsystem, wherein said heat exchanger is comprised of at least a first heat exchanger stage and a second heat exchanger stage, wherein said second conduit is serially coupled first to said first heat exchanger stage and second to said second heat exchanger stage, wherein said first conduit is coupled to said first heat exchanger stage, and wherein said second electrolytic heating subsystem is coupled to said second heat exchanger stage.

13. The power generating system of claim 9, further comprising a system controller coupled to at least one of said high voltage source and said pulse generator.

14. The power generating system of claim 9, wherein each high voltage cathode is comprised of a first material, wherein each high voltage anode is comprised of a second material, wherein each metal member of said plurality of metal members is comprised of a third material, and wherein said first, second and third materials are selected from the group consisting of titanium, stainless steel, copper, iron, steel, cobalt, manganese, zinc, nickel, platinum, palladium, aluminum, lithium, magnesium, boron, carbon, graphite, carbon-graphite, and metal hydrides and alloys of titanium, stainless steel, copper, iron, steel, cobalt, manganese, zinc, nickel, platinum, palladium, aluminum, lithium, magnesium, boron, carbon, graphite, carbon-graphite, and metal hydrides.

15. The power generating system of claim 9, further comprising an electromagnetic rate controller subsystem, said electromagnetic rate controller subsystem comprising:
at least one electromagnetic coil, said at least one electromagnetic coil generating a controllable magnetic field within a portion of said electrolysis tank; and
means for controlling magnetic field intensity of said magnetic field, wherein said controlling means is coupled to said at least one electromagnetic coil.

16. The power generating system of claim 9, further comprising at least one permanent magnet, said at least one permanent magnet generating a magnetic field within a portion of said electrolysis tank.

17. A method of generating electricity, the method comprising the steps of:
heating a liquid contained within an electrolysis tank of an electrolytic heating subsystem, wherein said liquid heating step further comprises the step of performing electrolysis in said electrolysis tank of said electrolytic heating subsystem, wherein said liquid heating step is performed by said electrolytic heating subsystem;
circulating said heated liquid from said electrolysis tank through a first conduit and through a heat exchanger coupled to said first conduit;
circulating a working fluid through a second conduit, wherein said second conduit is coupled to said heat exchanger, said working fluid circulating step further comprising the steps of heating said working fluid above the boiling point of the working fluid as the working fluid passes through said heat exchanger, and generating vapor as said working fluid is heated above the boiling point of the working fluid;
circulating said vapor through a steam turbine, wherein said vapor circulating step causes rotation of said steam turbine; and
rotating a drive shaft of a generator, wherein said drive shaft is coupled to said steam turbine, and wherein said drive shaft rotating step causes said generator to generate electricity.

18. The method of claim 17, wherein said heated liquid circulating step further comprises the steps of first circulating said heated liquid through a first stage of said heat exchanger and second circulating said heated liquid through a second stage of said heat exchanger, and wherein said working fluid circulating step further comprising the steps of first circulating said working fluid through said second stage of said heat exchanger and second circulating said working fluid through said first stage of said heat exchanger.

19. The method of claim 17, wherein said electrolysis performing step further comprises the steps of:
periodically measuring a temperature corresponding to said electrolytic heating subsystem;
comparing said measured temperature with a preset temperature; and
modifying at least one process parameter of said electrolytic heating subsystem when said measured temperature is above or below said preset temperature by more than a preset quantity.

20. The method of claim 17, wherein said electrolysis performing step further comprises the steps of:
periodically measuring a temperature corresponding to said liquid;
comparing said measured temperature with a preset temperature; and
modifying at least one process parameter of said electrolytic heating subsystem when said measured temperature is above or below said preset temperature by more than a preset quantity.

21. The method of claim 17, wherein said electrolysis performing step further comprises the steps of:
periodically measuring a temperature corresponding to said working fluid;
comparing said measured temperature with a preset temperature; and
modifying at least one process parameter of said electrolytic heating subsystem when said measured temperature is above or below said preset temperature by more than a preset quantity.

22. The method of claim 17, said electrolysis performing step further comprising the steps of:
applying a low voltage to at least one pair of low voltage electrodes contained within said electrolysis tank of said electrolytic heating subsystem, said at least one pair of low voltage electrodes fabricated from a first material, said low voltage applying step further comprising the step of pulsing said low voltage at a first frequency and with a first pulse duration
applying a high voltage to at least one pair of high voltage electrodes contained within said electrolysis tank, said at least one pair of high voltage electrodes fabricated from a second material, said high voltage applying step further comprising the step of pulsing said high voltage at said first frequency and with said first pulse duration, wherein said high voltage pulsing step is performed simultaneously with said low voltage pulsing step, and wherein said low voltage electrodes of said at least one pair of low voltage electrodes are positioned between said high voltage electrodes of said at least one pair of high voltage electrodes; and
selecting said first material and said second material from the group consisting of titanium, stainless steel, copper, iron, steel, cobalt, manganese, zinc, nickel, platinum, palladium, aluminum, lithium, magnesium, boron, carbon, graphite, carbon-graphite, and metal hydrides and alloys of titanium, stainless steel, copper, iron, steel, cobalt, manganese, zinc, nickel, platinum, palladium, aluminum, lithium, magnesium, boron, carbon, graphite, carbon-graphite, and metal hydrides.

23. The method of claim 22, further comprising the step of generating a magnetic field within a portion of said electrolysis tank, wherein said magnetic field affects a heating rate corresponding to said heat transfer medium heating step.

24. The method of claim 17, said electrolysis performing step further comprising the steps of applying a high voltage to at least one pair of high voltage electrodes contained within said electrolysis tank, said at least one pair of high voltage electrodes fabricated from a first material, said high voltage applying step further comprising the step of pulsing said high voltage at a first frequency and with a first pulse duration, wherein each pair of said at least one pair of high voltage electrodes includes at least one high voltage cathode electrode and at least one high voltage anode electrode, wherein each high voltage cathode electrode is positioned within a first region of said electrolysis tank and each high voltage anode electrode is positioned within a second region of said electrolysis tank, wherein at least a first metal member of a plurality of metal members fabricated from a second material is located within said first region of said electrolysis tank between said high voltage cathode electrodes and a membrane located within said electrolysis tank, and wherein at least a second metal member of said plurality of metal members is located within said second region of said electrolysis tank between said high voltage anode electrodes and said membrane, and further comprising the step of selecting said first material and said second material from the group consisting of titanium, stainless steel, copper, iron, steel, cobalt, manganese, zinc, nickel, platinum, palladium, aluminum, lithium, magnesium, boron, carbon, graphite, carbon-graphite, and metal hydrides and alloys of titanium, stainless steel, copper, iron, steel, cobalt, manganese, zinc, nickel, platinum, palladium, aluminum, lithium, magnesium, boron, carbon, graphite, carbon-graphite, and metal hydrides.

25. The method of claim 24, further comprising the step of generating a magnetic field within a portion of said electrolysis tank, wherein said magnetic field affects a heating rate corresponding to said heat transfer medium heating step.
